(19) United States
(12) Patent Application Publication
(10) Pub. No.: US 2025/0109981 A1
(43) Pub. Date: Apr. 3, 2025

(54) RESIDUAL PRODUCT WEIGHT TESTING METHOD

(71) Applicant: AMCOR FLEXIBLES NORTH AMERICA, INC., Neenah, WI (US)

(72) Inventors: Austin M. Walgurski, Green Bay, WI (US); Michele C. Payant, Oshkosh, WI (US); Joseph M. Oster, Oshkosh, WI (US)

(21) Appl. No.: 18/891,718

(22) Filed: Sep. 20, 2024

Related U.S. Application Data
(60) Provisional application No. 63/541,586, filed on Sep. 29, 2023.

(51) Int. Cl. G01G 19/64; B08B 3/08; B65D 65/38

(52) U.S. Cl. CPC G01G 19/64; B08B 3/08; B65D 65/38; B65D 2565/385

(57) ABSTRACT

Provided are methods for measuring residual amount of product remaining on a plastic product package for qualification of entry into a recycling program, the method including: determining whether a residual amount of product from the plastic product package is less than a qualifying amount for entry into the recycling program, where the plastic product package comprises a plastic package and the amount of residual product.

### CROSS REFERENCE TO RELATED APPLICATIONS

The present application claims the benefit of U.S. Provisional Application No. 63/541,586, filed Sep. 29, 2023, which is incorporated by reference herein in its entirety.

### TECHNICAL FIELD

This disclosure is related to methods useful for accurately and consistently measuring and calculating the residual product weight remaining on packaging after normal product use. The resulting information may be used to determine recyclability of a package in specific recycling processes.

### BACKGROUND

Store drop-off recycling programs allow for consumers to recycle plastic product packages at local retail stores. Certain flexible plastic packages can be recycled through store drop-off programs, such as flexible plastics made of high-density polyethylene (HDPE) and low-density polyethylene (LDPE), including grocery and produce bags, some bread bags, some plastic wraps, some plastic mailers, some cereal bags, and more. Programs such as How2Recycle® provide labels for plastic product packages to show whether the plastic product packages are eligible for the store drop-off programs, however, the labeling decision is based on subjective assessments of the individual product that will be in the product package.

Certain characteristics presently make a plastic product package ineligible for a store drop-off label, including, but not limited to, food or beverage products, personal or home care products, or any other similar products that are wet, moist, sticky, gooey, or oily; any products that are hazardous or potentially hazardous; any products that are dirt or dirt-like; or products that would be difficult or unreasonable for the consumer to prepare as clean and dry before recycling via store drop-off (e.g., would require scissors to cut off fitment to rinse the inside).

Current methods to determine the eligibility of a plastic product package for recycling are qualitative and create great uncertainty in the labeling process. Additionally, retailers with store drop-off programs are worried about food-contaminated films causing potential odors and pest issues in stores, and recycling plants are concerned about potential reprocessing challenges with food-contaminated films causing discoloration or odor in recycled materials.

### SUMMARY

Methods for quantitatively assessing the amount of product left in a package after normal use would be desirable, allowing for an objective standard to determine whether a plastic product package qualifies for recycling. According to an aspect of the present technology, a method for measuring an amount of residual product remaining on a plastic product package is provided. The method includes: removing substantially all residual product from a plastic product package that has been emptied of product as in normal course of use; determining quantitatively the weight of residual product removed; and calculating the percent residual product weight based on the total weight of the plastic product package and residual product.

In some embodiments, the method includes: emptying the plastic product package as in normal course of use; weighing the plastic product package having the amount of residual product to obtain an initial weight (W₁); rinsing the plastic product package with one or more solvents to remove substantially all of the amount of residual product from the plastic product package; weighing the rinsed plastic product package to obtain a final weight (W₂); and determining the percent residual product weight using the formula:

$$percent residual product weight = \frac{{W}_{1} - {W}_{2}}{{W}_{1}} \times 100 \% .$$

In another aspect, a method for measuring an amount of residual product remaining on a plastic product package for qualification of entry into a recycling program is provided. The method includes: emptying the plastic product package as in normal course of use; weighing the plastic product package having the residual amount of product to obtain an initial weight (W₁); rinsing the plastic product package with one or more solvents to remove substantially all of the residual amount of product from the plastic product package; weighing the rinsed plastic product package to obtain a final weight (W₂); and determining a percent residual product weight using the formula:

$$percent residual product weight = \frac{{W}_{1} - {W}_{2}}{{W}_{1}} \times 100 \% .$$

In some embodiments, the methods further include drying the plastic product package after emptying for a package drying period.

In some embodiments, the package drying period is at least about 24 hours.

In some embodiments, the rinsing step comprises rinsing the plastic product package having the amount of residual product with a non-polar solvent and with an aqueous solvent.

In some embodiments, the methods further comprise: drying the plastic product package for a first period of time after rinsing with the non-polar solvent; and drying the plastic product package for a second period of time after rinsing with the aqueous solvent.

In some embodiments, the first period of time is from about 10 minutes to about 20 minutes.

In some embodiments, the second period of time is at least about 1 hour.

In some embodiments, the non-polar solvent comprises one or more of pentane, hexane, heptane, or dichloromethane.

In some embodiments, the aqueous solvent comprises water.

In some embodiments, the plastic product package comprises a composition qualified for recycling.

In some embodiments, the composition qualified for recycling comprises one or more materials selected from the group consisting of polyolefin, polyethylene, polypropylene, polyester and paper.

In some embodiments, the composition of the package is qualified for a recycling process directed toward one or more of polyolefin, polyethylene, polypropylene, polyester and paper recycling.

In some embodiments, the plastic product package comprises a polyethylene-based film.

In some embodiments, the plastic product package is eligible for entry into a recycling program when the percent residual product weight is 0% to about 10.5%.

In some embodiments, the plastic product package is eligible for entry into a recycling program when the percent residual product weight is 0% to about 8%.

In some embodiments, the plastic product package comprises a fitment.

In some embodiments, emptying the plastic product package comprises emptying through the fitment.

In some embodiments, rinsing the plastic product package comprises rinsing through the fitment.

In some embodiments, the methods further comprise making an opening in the plastic product package and rinsing the plastic product package through the opening.

In some embodiments, no part of the plastic product package is removed from the plastic product package for the measurement.

In some embodiments, the residual product comprises a non-food product.

In some embodiments, the residual product comprises a food product.

In some embodiments, the food product comprises a condiment, pureed food product, dairy product, meat product, food product containing sugar, or a combination of two or more thereof.

In some embodiments, the residual product on the plastic package is wet, gooey, sticky, or oily.

In some embodiments, the residual product on the plastic package is dry and/or particulate.

### BRIEF DESCRIPTION OF THE DRAWINGS

FIG. 1A shows results of the residual product weight testing method using different types of food packaging. The contamination coat weight was determined for each food package after the food package was rinsed according to the methods described herein and discussed in the Examples section.

FIG. 1B shows results of the residual product weight testing method using different samples of food packaging. The percentage residual product weight was determined for each food package after the food package was rinsed according to the methods described herein.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In one aspect, provided herein is a method for measuring an amount of residual product remaining on a plastic product package for qualification of entry into a recycling program. Herein, “residual product” or “contamination” refers to any product remaining on a plastic product package after the plastic package has been emptied as in the normal course of use. High amounts of residual product (such as over 15 wt %) are unfavorable for reprocessing plastic product packages because they can result in discoloration of the reprocessed packages, or, in the case of residual food products, can promote microbial growth which leads to strong odors in the reprocessed packages.

In one aspect, a method for measuring an amount of residual product remaining on a plastic product package includes: removing substantially all residual product from a plastic product package that has been emptied of product as in normal course of use; and determining quantitatively the weight of residual product removed and calculating the percent residual product weight based on the total weight of the plastic product package and residual product. By “substantially all” is meant at least 95 wt %. In any embodiments, “substantially all” means at least 96 wt %, at least 97 wt %, at least 98 wt %, at least 99 wt %, at least 99.5 wt % or at least 99.9 wt %.

As used herein, emptying a package as in “normal course of use” refers to how a consumer would empty the package, typically removing all or substantially all of a product from its plastic package during use. For example, if the plastic package contained baby wipes, a consumer would remove all of the baby wipes, but would not further clean out the remaining liquid (the residual product). Similarly, processed meats such as sliced lunchmeat or bacon, a consumer would remove each of the product pieces (i.e., slices), but any grease or juice would remain in the package. Or, in the case of yogurt, the consumer would use a utensil to remove most of the product, but a small amount (of residual product) would remain in the corners of the package. For dry products, a consumer would just pour out the product, leaving (in some cases) dust/fines (the residual product) on the packaging. For products that are dry/semi-dry but may be sticky, such as shredded cheese, a consumer would again pour out the product, leaving (in some cases) a minimal amount of fines or even small shreds remaining on or in the packaging. If a package has a fitment or spout for dispensing, “normal course of use” includes emptying the package by pouring or squeezing the package so that the product is evacuated through the fitment, potentially leaving a small amount product behind either in the package or in the fitment itself.

In some embodiments, the method includes: emptying the plastic product package as in normal course of use; weighing the plastic product package having the amount of residual product to obtain an initial weight (W₁); rinsing the plastic product package with one or more solvents to remove substantially all of the amount of residual product from the plastic product package; weighing the rinsed plastic product package to obtain a final weight (W₂); and determining the percent residual product weight using the formula:

$$percent residual product weight = \frac{{W}_{1} - {W}_{2}}{{W}_{1}} \times 100 \% .$$

In another aspect, the present technology provides a method for measuring an amount of residual product remaining on a plastic product package for qualification of entry into a recycling program, the method comprising: emptying the plastic product package as in normal course of use; weighing the plastic product package having the residual amount of product to obtain an initial weight (W₁); rinsing the plastic product package with one or more solvents to remove substantially all of the residual amount of product from the plastic product package; weighing the rinsed plastic product package to obtain a final weight (W₂); and determining a percent residual product weight using the formula:

$$percent residual product weight = \frac{{W}_{1} - {W}_{2}}{{W}_{1}} \times 100 \% .$$

In yet another aspect, the present technology provides a method for measuring an amount of residual product remaining on a plastic product package for qualification of entry into a recycling program, the method comprising: emptying the plastic product package as in normal course of use; rinsing the plastic product package with one or more solvents to remove substantially all of the residual amount of product from the plastic product package; collecting the one or more solvents used to rinse the plastic product package; and analyzing the collected solvents to determine the amount of residual product on the plastic product package.

In some embodiments, the plastic product package comprises a composition qualified for recycling. Non-limiting examples of discrete compositions qualified for recycling include polyolefin, polyethylene, polypropylene, polyester and paper. In some embodiments, the composition qualified for recycling includes one or more materials selected from the group consisting of polyolefin, polyethylene, polypropylene, polyester and paper. In some embodiments, the composition qualified for recycling includes a material selected from the discrete groups consisting of polyolefin, polyethylene, polypropylene, and polyester. For example, a qualified composition may be one that is recyclable in a polyethylene stream. Or, a qualified composition may be one that is recyclable in a paper stream (i.e., in a repulping process). In some embodiments, compositions qualified for recycling that include paper also include a polymer component (e.g., polyolefin, polyethylene, polypropylene, and polyester). In some embodiments, the plastic product package comprises a polyethylene-based film.

In some embodiments, the method further includes drying the plastic product package after emptying for a package drying period. In some embodiments, the package drying period is at least about 24 hours. In some embodiments, the package drying period is about 12 hours, about 24 hours, about 30 hours, about 36 hours, about 42 hours, or about 48 hours, or a range between and including any two of the foregoing time periods.

In some embodiments, a package drying period is not required. For example, a dry product does not require a package drying period.

In some embodiments, the package drying period may be defined by time and environment. For example, a package drying period may include an ambient environment of 23° C. and 50% RH. A package drying period may include an environment at an elevated temperature, such as in a lab oven. A package drying period may include a desiccated environment. For example, a package drying period may include storage of the emptied package in a hot and dry environment (i.e., 100° F., 20% RH) for 12 hours or 24 hours. If more extreme environment conditions are used for the package drying period, the package may need to be conditioned at ambient conditions before completing the weighing steps.

In some embodiments, the rinsing step comprises rinsing the plastic product package having the amount of residual product with a non-polar solvent and with an aqueous solvent. Examples of the non-polar solvent include, but are not limited to, pentane, hexane, heptane, dichloromethane, or a mixture of two or more thereof. Other examples may include detergent based solvents. In some embodiments, the aqueous solvent comprises or is water.

In some embodiments, the method further comprises: drying the plastic product package for a first period of time after rinsing with the non-polar solvent; and drying the plastic product package for a second period of time after rinsing with the aqueous solvent.

In some embodiments, the first period of time is from about 10 minutes to about 20 minutes. In some embodiments, the first period of time is about 10 minutes, about 11 minutes, about 12 minutes, about 13 minutes, about 14 minutes, about 15 minutes, about 16 minutes, about 17 minutes, about 18 minutes, about 19 minutes, or about 20 minutes, or a range between and including any two of the foregoing values. The first period of time may be selected such that all the non-polar solvent has evaporated.

In some embodiments, the second period of time is at least about 1 hour. In some embodiments, the second period of time is about 1 hour, about 2 hours, about 4 hours, about 6 hours, about 8 hours, about 10 hours, about 12 hours, about 18 hours, or about 24 hours, or a range between and including any two of the forgoing values. The second period of time may be selected such that the weight has stopped changing, i.e., two consecutive measurements are consistent.

In some embodiments, the plastic product package is eligible for entry into a recycling program when the percent residual product weight is 0% to about 10.5%. In some embodiments, the plastic product package is eligible for entry into a recycling program when the percent residual product weight is 0% to about 8%. In some embodiments, the plastic product package is eligible for entry into a recycling program when the percent residual product weight is 0% to about 5%. In some embodiments, the plastic product package is eligible for entry into a recycling program when the percent residual product weight is 0% to about 15%. In some embodiments, the plastic product package is eligible for entry into a recycling program when the percent residual product weight is 0%, 0.25%, 0.5%, 0.75%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, 10.25%, 10.5%, 10.75%, 11%, 11.25%, 11.5%, 11.75%, 12%, 12.25%, 12.5%, 12.75%, 13%, 13.25%, 13.5%, 13.75%, 14%, 14.25%, 14.5%, 14.75%, 15%, 15.25%, 15.5%, 15.75%, 16%, 16.25%, 16.5%, 16.75%, 17%, 17.25%, 17.5%, 17.75%, 18%, 18.25%, 18.5%, 18.75%, 19%, 19.25%, 19.5%, 19.75%, 20%, 20.25%, 20.5%, 20.75%, 21%, 21.25%, 21.5%, 21.75%, 22%, 22.25%, 22.5%, 22.75%, 23%, 23.25%, 23.5%, 23.75%, 24%, 24.25%, 24.5%, 24.75%, 25%, 25.25%, 25.5%, 25.75%, 26%, 26.25%, 26.5%, 26.75%, 27%, 27.25%, 27.5%, 27.75%, 28%, 28.25%, 28.5%, 28.75%, 29%, 29.25%, 29.5%, 29.75% or 30%.

In some embodiments, the plastic product package comprises a fitment. In some embodiments, emptying the plastic product package comprises emptying through the fitment. In some embodiments, rinsing the plastic product package comprises rinsing through the fitment.

In some embodiments, the method further comprises making an opening in the plastic product package and rinsing the plastic product package through the opening. The opening may be made by cutting or tearing the plastic product packages, however, no part of the plastic product package is removed from the plastic product package for the measurement.

In some embodiments, the residual product comprises a non-food product. In some embodiments, the residual product comprises a food product. In some embodiments, residual product on the plastic package is wet, gooey, sticky, or oily. Products that are wet, gooey, sticky, or oily are often difficult to separate from the packaging material (i.e., emptying these packages fully may be difficult or impossible). In some embodiments, the residual product on the plastic package is dry and/or particulate. A residual product, be it dry, particulate, wet, gooey, sticky or oily, may be detectable by visual or tactile inspection (i.e., the residual product can be seen or felt).

In a preferred embodiment, the residual product weight testing method is as follows:
a. Apparatus: Analytical balance and Fume hood
b. Chemicals: Heptane and Water

Instrument Validation: Balances should be calibrated every six months.

### Sample Preparation:

Obtain a representative contaminated package with desired product. Note that the test will have to be carried out for different contaminating products (i.e., Same packaging material, but different product). Ensure that there are enough samples to acquire statistically significant data for each scenario.

Ensure package is emptied to represent end of use cleanliness. Samples can be tested using best case or worse case conditions.

Best Case—Package is emptied and shaken out slightly more and allowed to dry out completely before testing.

Worse Case—Package is emptied and is tested immediately.

If the product is wet, allow the sample to air dry until there is no more visible wetness. This step may take multiple hours depending on the sample.

### Procedure

Level and zero the analytical balance.

Weigh the contaminated package in grams, to at least the nearest 0.1 mg, making sure all the specimen is on the balance pan and does not touch the frame or wind shield. Record as W1.

Add heptane to the package and reseal or close the package.

8 mL heptane per 10 in² of interior surface area is typically sufficient, although packages with a high amount of residual product may need more.

Agitate the package until all contaminant is suspended in the heptane, roughly 15-30 seconds.

Open the package and pour out the heptane. Rinse the package using a squirt bottle containing heptane at least twice.

Collect heptane waste and dispose of in correct waste stream.

Leave the package to dry in a fume hood, 15 minutes is enough time for most packages.

Add water to the same package.

8 mL water per 10 in² of interior surface area is typically sufficient, although packages with a high amount of residual product may need more.

Agitate the package until all remaining residue is suspended in the water, roughly 15-30 seconds.

Open the package and pour out the water. Rinse the package using a squirt bottle containing water.

Collect water waste and dispose of in a correct waste stream.

Open package and leave in fume hood until dry, one hour or more may be required. Opening the seals of the package will help reduce the time needed to dry.

Once package is dried, level and zero balance, and reweigh the specimen to the nearest 0.1 mg, making sure all of the specimen is on the balance pan and does not touch the frame or wind shield. Record as W2.

### Calculations/Reporting

Use the equation (W1-W2)/W1 to calculate residual product weight %.

Average the three samples run in triplicate.

Report residual product weight %.

In some embodiments, the food product comprises a condiment, a pureed food product, a dairy product, a meat product, a food product containing sugar, or any combination of thereof. Examples of the condiment include, but are not limited to mustard, mayonnaise, ketchup, soy sauce, vinegar, oils, salsa, Worcestershire sauce, marmite, wasabi, barbecue sauces, dressings, relish, chili sauce, dips, fruit preserves, honey, horseradish, syrup, teriyaki sauce, and hot sauces. Non-limiting examples of the pureed food product include food products that have been ground, pressed, and/or strained to a soft, smooth consistency such as wet baby food, wet pet food, nut butters, and pureed fruits and vegetables. Examples of the dairy product may include, but are not limited to, cheese, milk, cream, yogurt, butter, and dairy-based desserts. Examples of the meat product include, but are not limited to, deli meat, bacon, sausages or hot dogs, and jerky. Examples of the food product containing sugar include, but are not limited to, confectioneries, chocolate confectioneries, gum, pastries, cakes, cookies, gelatins, puddings, and sugar-containing beverages such as sodas, juices, and smoothies. Examples of food products may include non-meat protein sources (i.e., tofu, plant-based protein, eggs), nuts, chocolate, cheese, pet foods (dry or wet), or chips/crackers. Food products may include products that are supplements, pharmaceutical, and/or nutraceutical in nature, or combinations thereof.

Non-food products include, but are not limited to, liquid soaps and detergents such as hand soap, dish soap, facial and body cleansers, laundry detergent, and fabric softener; liquid hair and skin care such as shampoo, hair conditioner, lotions; and liquid oral care such as toothpaste and mouthwash. Non-food products may be textile in nature, such as baby wipes or facial wipes. The non-food product may be consumer, industrial, or chemical products.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The present invention, thus generally described, will be understood more readily by reference to the following examples, which are provided by way of illustration and are not intended to be limiting of the present invention.

### EXAMPLES

### Example 1—Surface Contamination Method Development

Vegetable shortening was used as an oil simulant and corn syrup was used as a sugar simulant. The vegetable shortening and/or corn syrup was wiped on the inside of the pouch with a paper towel. An amount that is typical of a very heavily contaminated sample was used to verify that the solvent would fully clean all samples. The solvent was added to the pouch and then the pouch was sealed. Shaking the pouch for 3-5 minutes was sufficient to remove all the contaminant (i.e., residual product). The pouch was opened and the contents were poured out. The pouch was then rinsed out with a squirt bottle of the solvent used. It was rinsed twice with roughly 10 mL, but additional solvent may be used if some contaminant was left in the pouch. The pouch was then cut open and dried in a hood. The pouch was dried for about 1 hour after rinsing with water or until the water was no longer visible and then was dried for about 5 minutes in a fume hood after rinsing with heptane.

The samples were weighed empty, with the contaminant (vegetable shortening and/or corn syrup residual product), and after drying.

Water worked very well at removing the corn syrup and heptane worked very well at removing the vegetable shortening (Table 1). No solvent was found that could remove both the corn syrup and vegetable shortening effectively. 50 mL of solvent worked well for this size of package, but the amount may be increased or decreased if the package size is significantly different.

In the data of Table 1, V1 is the control which was an empty pouch with no contaminate. V2 and V3 are pouches with the noted contamination.

TABLE 1
Measurements and Calculated Residual Weight of Testing

| | | | Pouch & | | Pouch | Residual | |
|---|---|---|---|---|---|---|---|
| | | Pouch wt | Contam | Contam | Clean wt | Contam | Residual |
| | | (g) | (g) | (g) | (g) | (g) | (mg/in2) |
| Contaminate = | V1 | 9.7495 | 9.7507 | 0.0012 | 9.7504 | 0.0009 | 0.006 |
| Corn Syrup | (Control) | | | | | | |
| Solvent = | V2 | 9.7263 | 11.9852 | 2.2589 | 9.7286 | 0.0023 | 0.015 |
| Water | V3 | 9.8095 | 10.9924 | 1.1829 | 9.8030 | −0.0065 | −0.043 |
| Contaminate = | V1 | 9.7896 | 9.7923 | 0.0027 | 9.7929 | 0.0033 | 0.022 |
| Vegetable | (Control) | | | | | | |
| Shortening | V2 | 9.8354 | 10.2584 | 0.4230 | 9.8227 | −0.0127 | −0.085 |
| Solvent = | V3 | 9.8064 | 10.3912 | 0.5848 | 9.8071 | 0.0007 | 0.005 |
| Heptane | | | | | | | |
| Contaminate = | V1 | 9.7083 | 9.7031 | −0.0052 | 9.7024 | −0.0059 | −0.039 |
| Corn Syrup | (Control) | | | | | | |
| and Vegetable | V2 | 9.7566 | 10.9581 | 1.2015 | 9.7658 | 0.0092 | 0.061 |
| Shortening | V3 | 9.8405 | 11.0317 | 1.1912 | 9.8438 | 0.0033 | 0.022 |
| Solvent = | | | | | | | |
| Water/Heptane | | | | | | | |

If a sample is expected to have both oil and sugar components, the sample will need to be washed with both heptane and water. This was tested by applying both vegetable shortening and corn syrup to a pouch. The heptane wash was done first because heptane dries faster than water, and especially because the package cannot be cut completely before the second wash. After the heptane wash was done and the package dried, a second wash with water was done with the pouch being resealed as close to the edge as possible to avoid losing too much package surface area. The test was finished as normal. Washing twice to remove all of the contaminants.

In summary, the washing methods with heptane and water removed all of the simulated contaminants even when used successively on the same pouch. Washes with both types of solvents may be necessary to avoid missing contaminants.

### Example 2—Residual Product Testing

The methods described herein were used to determine the residual food contamination weight on several different product packages. The samples included: baked crackers, chocolate bars, shredded cheese, chunk cheese, cheese slices, sliced deli meat, uncooked bacon and bologna.

Prior to initial weighing, the packages were shaken out and allowed to dry out before weighing. The packages were emptied according to normal course of use. The packages were not wiped out or cleaned in any other way.

The results of the test are displayed as contamination weight and residual product weight percentages (i.e., contamination weight percentage), which were calculated according to the following equations:

$$Contamination Weight = \frac{( {W}_{1} - {W}_{2} )}{Surface area of the package} \\ Percent Residual Product Weight = \frac{{W}_{1} - {W}_{2}}{{W}_{1}} \times 100 \%$$

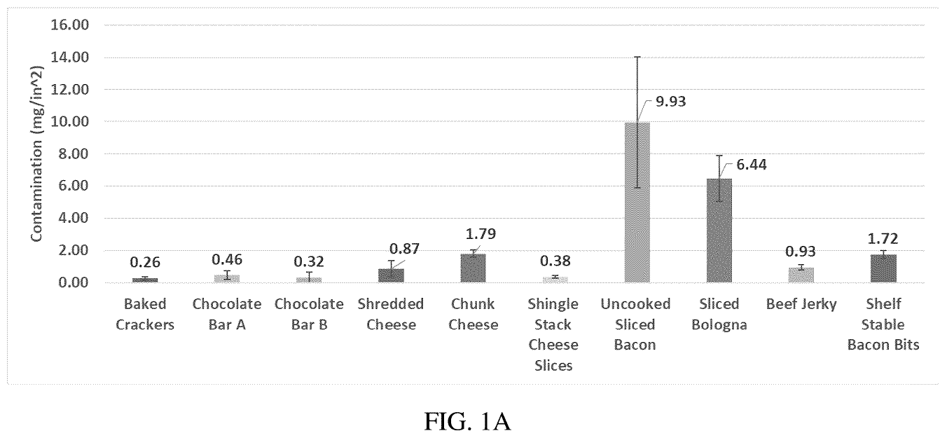

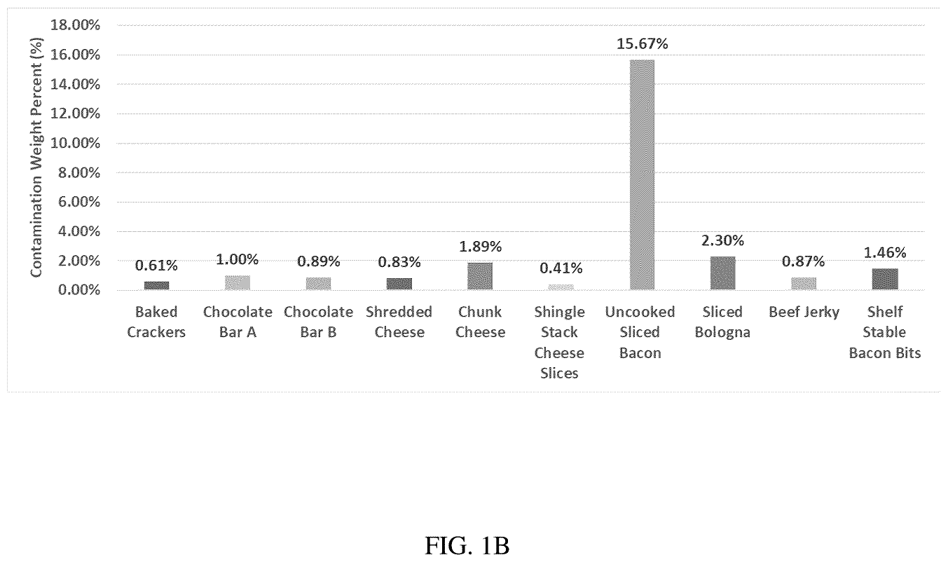

The contamination weights of the food packages are shown in FIG. 1A and are summarized in Table 2. Overall, the food package containing the uncooked sliced bacon had the highest contamination weight (9.77 mg/in² or 9.93 mg/in²), followed by the bologna (6.44 mg/in²). The contamination weights of the other food packages were all 1.77 mg/in² or 1.79 mg/in² and below.

The percent residual product weights of the packages are shown in FIG. 1B and are summarized in Table 2. The food package containing the uncooked sliced bacon had the highest contamination weight percentage (15.67%), followed by the sliced bologna (2.30%). The contamination weight percentages of the other food packages were all 1.89% and below.

The uncooked bacon product package is likely considered unrecyclable due to the contamination level (15.67%). The beef jerky and shelf stable bacon bits packages (0.87% and 1.46% residual product contamination, respectively) are accepted today in typical recycling processes (in-store drop off).

TABLE 2
Measurements and Calculated Residual Weight of Testing

| | Contamination | Contamination |
|---|---|---|
| | Weight | Weight |
| Product | (mg/in²) | Percent (%) |
| Baked Crackers | 0.26 | 0.61 |
| Chocolate Bar A | 0.46 | 1.0 |
| Chocolate Bar B | 0.32 | 0.89 |
| Shredded Cheese | 0.87 | 0.83 |
| Chunk Cheese | 1.79 | 1.89 |
| Shingle Stack Cheese Slices | 0.38 | 0.41 |
| Uncooked Sliced Bacon | 9.93 | 15.67 |
| Sliced Bologna | 6.44 | 2.3 |
| Beef Jerky | 0.93 | 0.87 |
| Shelf Stable Bacon Bits | 1.72 | 1.46 |

Further products and packages were tested in the same manner and the results are shown in Table 3.

TABLE 3
Measurements and Calculated Residual Weight of Testing

| | | Contamination | Contamination |
|---|---|---|---|
| | Package | Weight | Weight |
| Product | Format | (mg/in²) | Percent (%) |
| Brown Sugar | Pillow Pack | 6.5 | 13.0 |
| Flour | Stand-Up Pouch | 2.86 | 2.84 |
| Brown Sugar | Stand-Up Pouch | 36.1 | 24.8 |
| Shelled Walnuts | Stand-Up Pouch | 1.25 | 1.2 |
| Chopped Pecans | Pillow Pack | 0.73 | 0.98 |
| Dry Cereal 1 | Pillow Pack | 0.53 | 1.4 |
| Dry Cereal 2 | Pillow Pack | 0.42 | 1.1 |
| Dry Cereal 3 | Pillow Pack | 1.3 | 3.4 |
| Granola Bar | Flow Wrap | 8.49 | 16.8 |
| Cookie Snack | Pillow Pack | 0.31 | 0.71 |
| Seasoned Crackers 1 | Pillow Pack | 0.87 | 2.38 |
| Seasoned Crackers 2 | Pillow Pack | 1.1 | 2.94 |
| Seasoned Crackers 3 | Pillow Pack | Not available | 3.51 |
| Seasoned Crackers 4 | Pillow Pack | Not available | 3.8 |
| Seasoned Crackers 5 | Pillow Pack | Not available | 4.64 |
| Seasoned Crackers 6 | Pillow Pack | Not available | 3.86 |
| Chocolate Chips 1 | Pillow Pack | Not available | 0.76 |
| Chocolate Chips 2 | Pillow Pack | Not available | 0.75 |
| Chocolate Candy 1 | Flow Wrap | Not available | 0.33 |
| Chocolate Candy 2 | Pillow Pack | Not available | 0.08 |
| Uncooked Thick | Flexible | Not available | 28.0 |
| Sliced Bacon | form/nonform | | |
| Sliced Deli Meat | Tray and Lid | Not available | 1.78 |
| Sour Cream | Rigid Container | Not available | 14.5 |
| Dog Treats | Stand-Up Pouch | Not available | 0.01 |
| Almonds | Stand-Up Pouch | Not available | 1.7 |
| Chips | Pillow Pack | Not available | 11.35 |

### Example 3—Residual Product Testing, Package Drying Analysis

Packaging containing products including beef jerky, bacon bits, shredded cheese or chunk cheese were emptied according to normal course of use. These packages were then dried at varying time periods including 0 days, 2 weeks and 4 weeks. After drying, the packages were then rinsed and dried according to the protocol herein. The residual product weight percent varied less than 1% over these drying periods. For products similar to these, the package drying period may not be critical.

### EQUIVALENTS

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent formulations and methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, reagents, compounds, or compositions, which can of course, vary. All methods described herein can be performed in any suitable order unless otherwise indicated herein or otherwise clearly contradicted by context. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether or not the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims and include the full scope of equivalents to which such claims are entitled.

What is claimed is:

1. A method for measuring an amount of residual product remaining on a plastic product package, the method comprising:
a first step of removing substantially all residual product from a plastic product package that has been emptied of product;
a second step of weighing the plastic product package having the amount of residual product to obtain an initial weight (W₁);
a third step of rinsing the plastic product package having the amount of residual product with a non-polar solvent;
an optional fourth step of drying the plastic product package having the amount of residual product after rinsing with a non-polar solvent;
a fifth step of rinsing the plastic product package having the amount of residual product with water;
a sixth step of drying the plastic product package having the amount of residual product after rinsing with water for a drying period; and
a seventh step of weighing the rinsed and dried plastic product package to obtain a final weight (W₂); and
an eight step of determining the percent residual product weight using the formula:
$$percent residual product weight = \frac{{W}_{1} - {W}_{2}}{{W}_{1}} \times 100 \% .$$

2. The method of claim 1 wherein the non-polar solvent is heptane.

3. The method of claim 1 wherein the drying period in the optional fourth step is 10 to 20 minutes.

4. The method of claim 1 wherein the drying period in the sixth step is at least one hour.

5. The method of claim 1 wherein the plastic product package comprises a composition qualified for recycling.

6. The method of claim 5 wherein the composition is qualified for a recycling process directed toward one or more of polyolefin, polyethylene, polypropylene, polyester and paper recycling.

7. The method of claim 5, wherein the plastic product package comprises a polyethylene-based film.

8. The method of claim 1, wherein the plastic product package is eligible for entry into a recycling program when the percent residual product weight is 0% to about 10.5%.

9. The method of claim 1, wherein the plastic product package is eligible for entry into a recycling program when the percent residual product weight is 0% to about 8%.

10. A method for measuring an amount of residual product remaining on a plastic product package for qualification of entry into a recycling program, the method comprising:
emptying the plastic product package as in normal course of use;
weighing the plastic product package having the residual amount of product to obtain an initial weight (W₁);
rinsing the plastic product package with one or more solvents to remove substantially all of the residual amount of product from the plastic product package; and
weighing the rinsed plastic product package to obtain a final weight (W₂); and
determining a percent residual product weight using the formula:
$$percent residual product weight = \frac{{W}_{1} - {W}_{2}}{{W}_{1}} \times 100 \% .$$

11. The method of claim 10, further comprising drying the plastic product package after emptying for a package drying period.

12. The method of claim 10, wherein the plastic product package comprises a fitment and the step of emptying the plastic product package comprises emptying through the fitment and rinsing through the fitment.

13. The method of claim 10, wherein the method further comprises making an opening in the plastic product package and rinsing the plastic product package through the opening.

14. The method of any one of claims 10-13, wherein no part of the plastic product package is removed from the plastic product package for the measurement.

15. The method of any one of claims 10-13, wherein the plastic product package comprises a composition qualified for recycling.

16. The method of claim 15, wherein the composition is qualified for a recycling process directed toward one or more of polyolefin, polyethylene, polypropylene, polyester and paper recycling.

17. The method of any one of claims 10-13, wherein the rinsing step comprises rinsing the plastic product package having the amount of residual product with a non-polar solvent and with an aqueous solvent.

18. The method of claim 17, wherein the method further comprises:
drying the plastic product package for a first period of time after rinsing with the non-polar solvent; and
drying the plastic product package for a second period of time after rinsing with the aqueous solvent.

19. The method of claim 10, wherein the non-polar solvent comprises one of more of pentane, hexane, heptane, or dichloromethane, and the aqueous solvent is water.

20. The method of claim 16, wherein the plastic product package is eligible for entry into the recycling program when the percent residual product weight is from 0% to about 10.5%, preferably from about 0% to about 8%.
